(19) United States
(12) Patent Application Publication
(10) Pub. No.: US 2025/0244087 A1
(43) Pub. Date: Jul. 31, 2025

(54) PANEL TYPE RADIATOR WITH REINFORCING RIBS AND COOLING FINS IN LINTEL WELDING

(71) Applicant: SHENYANG TIANTONG ELECTRICITY CO., LTD., Shenyang (CN)

(72) Inventors: Cheng WAN, Shenyang (CN); Dan HAO, Shenyang (CN); Yao JIA, Shenyang (CN); He ZHU, Shenyang (CN); Chengshuai WANG, Shenyang (CN); Bin LI, Shenyang (CN); Chen ZHAO, Shenyang (CN); Chunxue WU, Shenyang (CN); Junzhi LIU, Shenyang (CN); Peijun ZHANG, Shenyang (CN)

(21) Appl. No.: 18/875,698

(22) PCT Filed: Jun. 29, 2023
(86) PCT No.: PCT/CN2023/103955

§ 371 Date: Dec. 16, 2024

(30) Foreign Application Priority Data
Jul. 11, 2022 (CN) 202221813194.3

(51) Int. Cl. F28F 3/12; F28F 3/04; F28F 9/02

(52) U.S. Cl. CPC F28F 3/12; F28F 3/048; F28F 9/0243; F28F 9/026; F28F 2225/04; F28F 2275/06

(57) ABSTRACT

Provided is a panel type radiator with reinforcing ribs and cooling fins in lintel welding, which includes multiple cooling fins, two oil collecting tubes, multiple reinforcing ribs and multiple welding seams. Each cooling fin is formed by welding two cooling sub-fins oppositely arranged. An edge of a long side of the cooling fin intersects with an outer surface of the reinforcing rib, and a gap suitable for a lintel-shaped weld is provided at an intersection. A welding material droplet weld is formed between an outer edge at an attached position of the long side of the cooling fin and the outer surface of the reinforcing rib, and the shape of the weld is lintel-shaped. The lintel-shaped weld is divided into three regions. The welding material fusion welding connection lintel region is self-fusion welding metal of the welding material.

### CROSS-REFERENCE TO RELATED APPLICATION

This application is a national stage application of International Patent Application No. PCT/CN2023/103955, filed on Jun. 29, 2023, which claims the priority of Chinese Patent Application No. 2022218131943 entitled “PANEL TYPE RADIATOR WITH REINFORCING RIBS AND COOLING FINS LINTEL-WELDED” filed with the Chinese Patent Office on Jul. 11, 2022, which is incorporated herein by reference in its entirety.

### TECHNICAL FIELD

The present disclosure belongs to the field of processing and manufacturing of panel type radiators for transformers, and in particular to a panel type radiator with reinforcing ribs and cooling fins in lintel welding.

### BACKGROUND

The existing welding methods for multiple radiating fins and multiple reinforcing ribs of the panel type radiator for a transformer are as follows: both sides of the reinforcing ribs and two or more points on the sides of the cooling fins are in tack welding, and the number of tack welding is large; meanwhile, there are welding blind zones at the attached positions of the reinforcing ribs and the cooling fins and narrow regions thereof, and the welding blind zones lead to welding defects and are difficult for visual inspection. The welding defects cause the coating sagging, poor one-pass hiding power, film surface shrinkage, pinhole, uneven surface, lack of fullness and gloss of the external paint, etc. After a period of time, there will be anti-corrosion defects such as cracking, peeling, foaming and rusting. The above defects, which are not easy to find, have become the corrosion hidden danger of the panel type radiator for the transformer, and are easy to cause the leakage of transformer oil. If the above defects need to be reduced, the radiator needs to be turned over many times during the welding of the cooling fins and the reinforcing ribs, thus avoiding the welding blind zones. Then, the existing tack welding process needs to be changed into a continuous welding process to implement full-length welding on multiple radiating fins and multiple reinforcing ribs. Because the spacing between the cooling fins is usually a narrow space of 45 mm, it is difficult to adjust the welding gun to the best welding attitude for full-length welding. Therefore, such a method can only reduce the number of defects before, but cannot be completely avoid the defects.

In conclusion, due to the existing tack welding and continuous welding methods for multiple cooling fins and multiple reinforcing ribs in the panel type radiator industry for transformers, high welding defect rate of the tack welding affects the later anti-corrosion quality, which leads to the leakage of radiators and a significant increase in the later repair rate. Although the use of the continuous welding method can reduce the welding defects, the continuous welding method is labor-consuming and time-consuming, which greatly reduces the work efficiency and increases the use cost of welding materials. Moreover, the welding defects will reduce the anti-corrosion quality of the panel type radiator for transformer and shorten the service life of the panel type radiator for transformer.

### SUMMARY

The present disclosure provides a panel type radiator with reinforcing ribs and cooling fins in lintel welding, with objectives of manufacturing an efficient, high-quality, low-consumable, low-repair-rate plate radiator with welded reinforcing ribs and cooling fins.

A panel type radiator with reinforcing ribs and cooling fins in lintel welding including multiple cooling fins, two oil collecting tubes, multiple reinforcing ribs and multiple welding seams. Each of the multiple cooling fins is formed by welding two cooling sub-fins oppositely arranged with a sheet thickness of 1.0-1.2 mm at attached positions of peripheral sides and attached positions of middle portions of the two cooling sub-fins. Each of the cooling fins includes: two confluence ports, one of the two confluence ports is configured for cooling fin oil to divert into oil channels after entering, and another of the two confluence ports is configured for the cooling fin oil in the oil channels to flow out after confluence; and the oil channels correspondingly opposed to form an oil chamber and communicating with the confluence ports. The attached positions of the peripheral sides include two attached positions of long sides, and four attached positions of short sides separated by the two confluence ports. Edges of long sides of the multiple cooling fins intersect and overlap with outer surfaces of the multiple reinforcing ribs, and the two attached positions of the long sides of each of the multiple cooling fins are symmetrically arranged along an axis of each of the two oil collecting tubes. The multiple welding seams include continuous welding seams between the two confluence ports of the multiple cooling fins and outer surfaces of two oil collecting tubes, and tack welding seams between outer edges of the attached positions of the long sides of the multiple cooling fins and the multiple reinforcing ribs, thus making lengths of diagonal lines of the panel type radiator equal and the axis of each of the two oil collecting tubes perpendicular to side lines of the long sides of the multiple cooling fins, and satisfying a firm connection between the multiple cooling fins.

The edges of the long sides of the multiple cooling fins of the panel type radiator intersect with the outer surfaces of the multiple reinforcing ribs, and gaps suitable for lintel-shaped welding seams are provided at intersections. Welding material droplet welding seams are formed between the outer edges of the attached positions of the long sides of the multiple cooling fins and the outer surfaces of the multiple reinforcing ribs, and a shape of each of the welding material droplet welding seams is lintel-shaped. Each of the lintel-shaped welding seams is divided into three regions including a first fusion welding region formed by a welding material and the multiple reinforcing ribs, a second fusion welding region formed by the welding material and the multiple cooling fins, and a welding material fusion welding connecting lintel region between the first fusion welding region and the second fusion welding region. The welding material fusion welding connecting lintel region is self-fusion welding metal of the welding material.

The panel type radiator with reinforcing ribs and cooling fins in lintel welding provided by the embodiments has the advantages that the gap between the cooling fin of the panel type radiator for a transformer and the welded reinforcing rib is 3 mm. The weld is lintel-shaped, there is no welding blind zone, and thus the difficulty of visual inspection is reduced. The lintel-shaped weld is one point, which can achieve the reinforcement connection between the cooling fins and reduce the consumption of consumables. The gap between the cooling fin and the welded reinforcing rib is 3 mm, such that the welding defect rate is reduced, the anti-corrosion quality at the welded weld is improved, and the late repair rate is reduced. On the premise that the welding efficiency is improved, the anti-corrosion quality of the product is ensured, and the manufacturing cost of the product is reduced, the service life of the panel type radiator for the transformer is improved.

### BRIEF DESCRIPTION OF THE DRAWINGS

FIG. 1 is a partial schematic view of the shape of a lintel-shaped weld between a reinforcing rib and a cooling fin and three fusion welding regions of a lintel-shaped weld;

FIG. 2 is a partial schematic view of the shape of the lintel-shaped weld between the reinforcing rib and the cooling fin;

FIG. 3 is a partial schematic view of tack welding between an existing cooling fin and a reinforcing rib;

FIG. 4 is an axonometric schematic view of a panel type radiator with reinforcing ribs and cooling fins in lintel welding;

FIG. 5 is a front schematic view of the panel type radiator with reinforcing ribs and cooling fins in lintel welding, and an attitude of a welding gun;

FIG. 6 is a partially enlarged front view of an arc striking position of lintel welding of the reinforcing rib and the cooling fin in FIG. 5;

FIG. 7 is a partially enlarged front view of an arc ending position of lintel welding of the reinforcing rib and the cooling fin in FIG. 5;

FIG. 8 is a top view of FIG. 5;

FIG. 9 is a partially enlarged top view of the arc striking position of lintel welding of the reinforcing rib and the cooling fin in FIG. 8;

FIG. 10 is a partially enlarged top view of the arc ending position of lintel welding of the reinforcing rib and the cooling fin in FIG. 8;

FIG. 11 is a front schematic view and cross-sectional view of the cooling fin;

FIG. 12 is a partially enlarged view of the shape of the lintel-shaped welding seam and the three fusion welding regions of the lintel-shaped welding seam when an oil collecting tube of the radiator is in an attitude horizontal to a horizontal plane;

FIG. 13 is a right view of FIG. 12;

FIG. 14 is a schematic view of an attitude of the oil collecting tube of the panel type radiator with reinforcing ribs and cooling fins in lintel welding horizontal to the horizontal plane, and the attitude of the welding gun;

FIG. 15 is a partially enlarged front view of the arc striking position of lintel welding of the reinforcing rib and the cooling fin in FIG. 14;

FIG. 16 is a partially enlarged front view of the arc ending position of lintel welding of the reinforcing rib and the cooling fin in FIG. 14;

FIG. 17 is a right view of FIG. 14;

FIG. 18 is a partially enlarged front view of the arc striking position of lintel welding of the reinforcing rib and the cooling fin in FIG. 17;

FIG. 19 is a partially enlarged front view of the arc ending position of lintel welding of the reinforcing rib and the cooling fin in FIG. 17.

List of the reference characters: 1 cooling fin; 2 oil collecting tube; 3 reinforcing rib; 4 edge of long side; 5 outer edge of attached position of long side, 6 tack welding seam, 7 lintel-shaped welding seam; and 8 welding gun.

### DETAILED DESCRIPTION OF THE EMBODIMENTS

The present disclosure is further described below in detail with reference to accompanying drawings and embodiments.

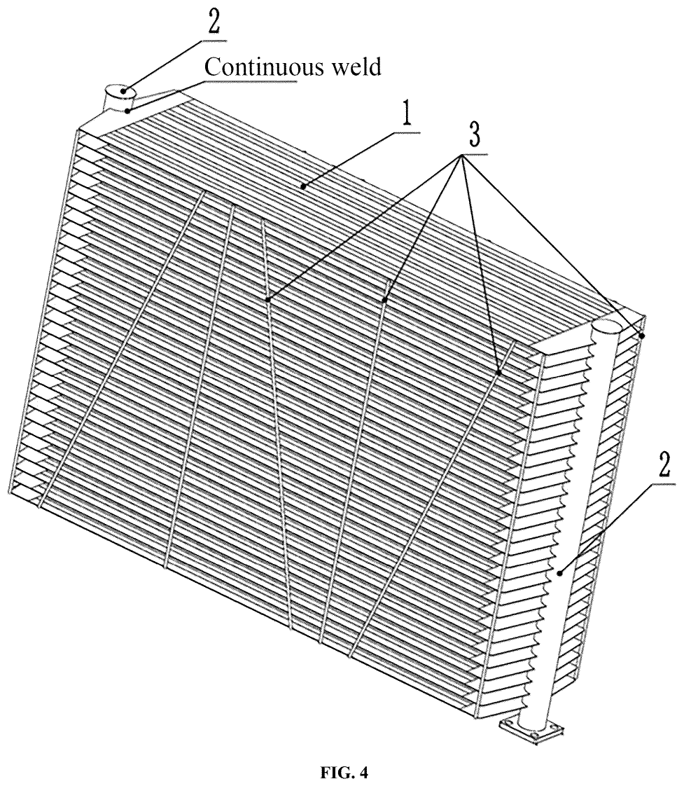

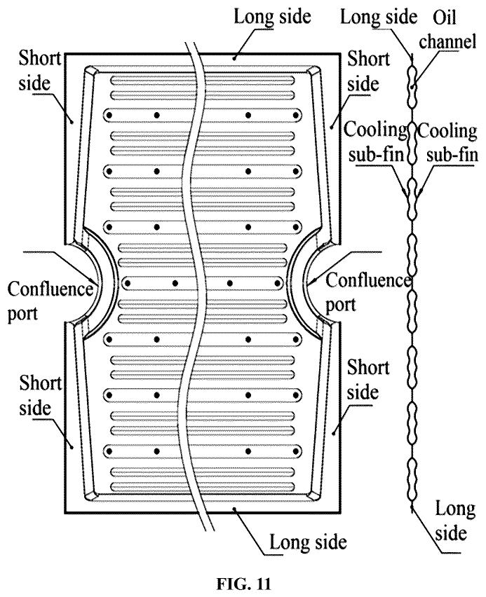

Embodiment 1: referring to FIG. 4 and FIG. 11, a panel type radiator with reinforcing ribs and cooling fins in lintel welding includes multiple cooling fins 1, two oil collecting tubes 2, multiple reinforcing ribs 3 and multiple welding seams. Each cooling fin 1 is formed by welding two opposite cooling sub-fins oppositely arranged with a sheet thickness of 1.0-1.2 mm at attached positions of peripheral sides and attached positions of middle portions of the two opposite cooling sub-fins. The cooling fin 1 includes two confluence ports. One of the two confluence ports is configured for cooling fin oil 1 to divert into oil channels after entering, and the other is configured for the oil in the oil channels to flow out after confluence. The oil channels are correspondingly opposed to form an oil chamber to communicate with the confluence ports. The attached positions of the peripheral sides include two attached positions of long sides and four attached positions of short sides separated by the two confluence ports. Edge 4 of long sides of the cooling fins 1 intersect with outer surfaces of the reinforcing ribs 3, and the two attached positions of the long sides of the cooling fin 1 are symmetrically arranged along an axis of the oil collecting tube 2. The welding seams include continuous welding seams between the two confluence ports of the multiple cooling fins 1 and the outer surfaces of two oil collecting tubes 2, and tack welding seams 6 between the outer edges 5 of the attached positions of the long sides of the multiple cooling fins 1 and the multiple reinforcing ribs 3, thus making lengths of diagonal lines of the radiator equal and the axes of the oil collecting tubes 2 perpendicular to side lines of the long sides of the multiple cooling fins 1, and satisfying a firm connection between the multiple cooling fins 1.

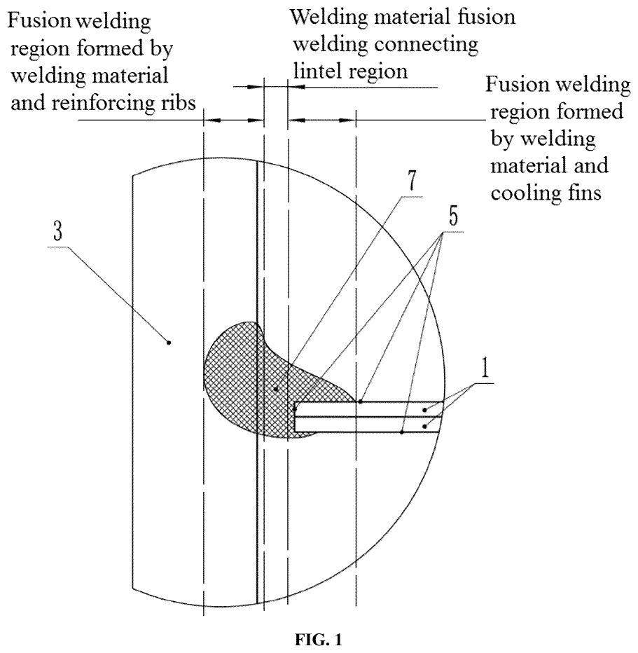

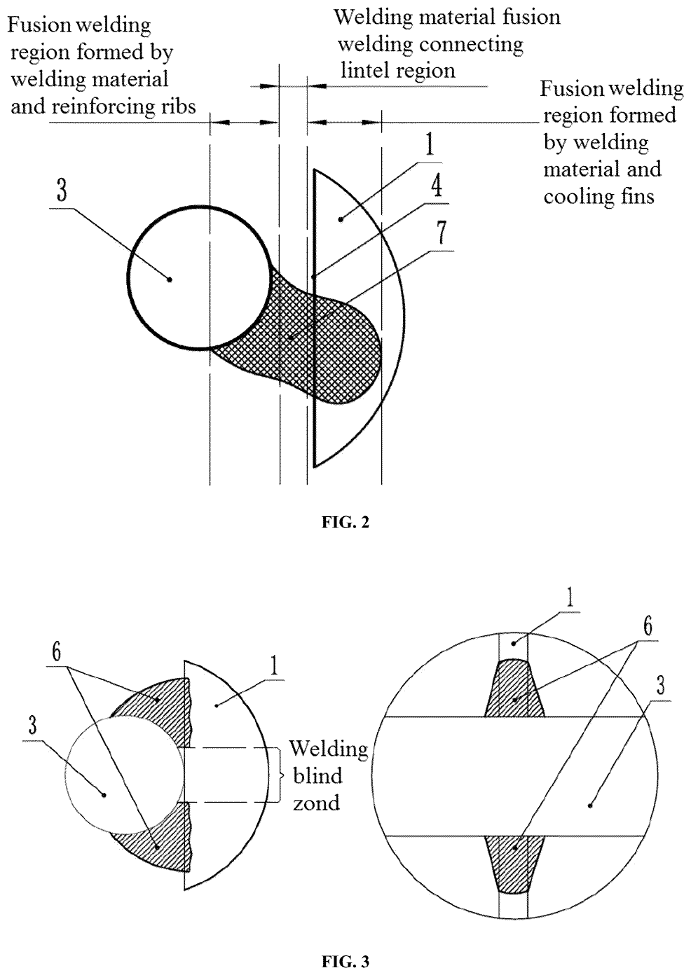

Referring to FIG. 1 and FIG. 2, the edges of the long sides of the cooling fins 1 of the radiator intersect with the outer surfaces of the reinforcing ribs 3, and a gap of 1-4 mm suitable for a lintel-shaped welding seam 7 is provided at intersection. More preferably, the gap is 3 mm. A welding material droplet welding seam is formed between an outer edge 5 of the attached position of the long side of the cooling fin 1 and the outer surface of the reinforcing rib 3, and the shape of the welding seam is lintel-shaped. The lintel-shaped welding seam 7 is divided into three regions that are a fusion welding region formed by a welding material and the reinforcing ribs, a fusion welding region formed by the welding material and the cooling fins and a welding material fusion welding connecting lintel region therebetween; and the welding material fusion welding connecting lintel region is self-fusion welding metal of the welding material. The shape of the reinforcing rib 3 is not only limited to the shape shown in the figure.

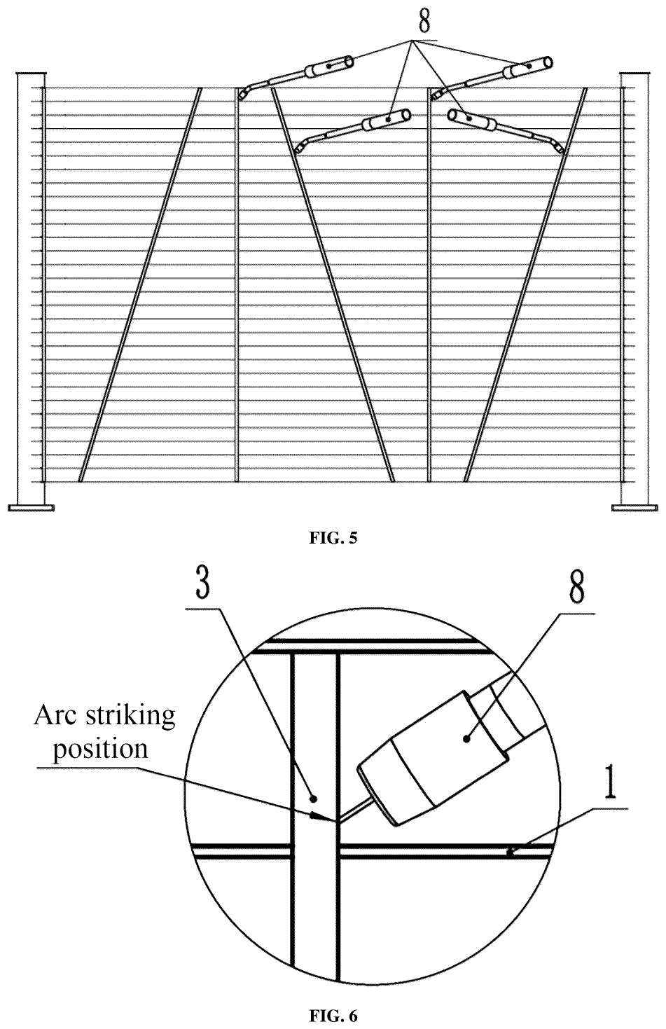

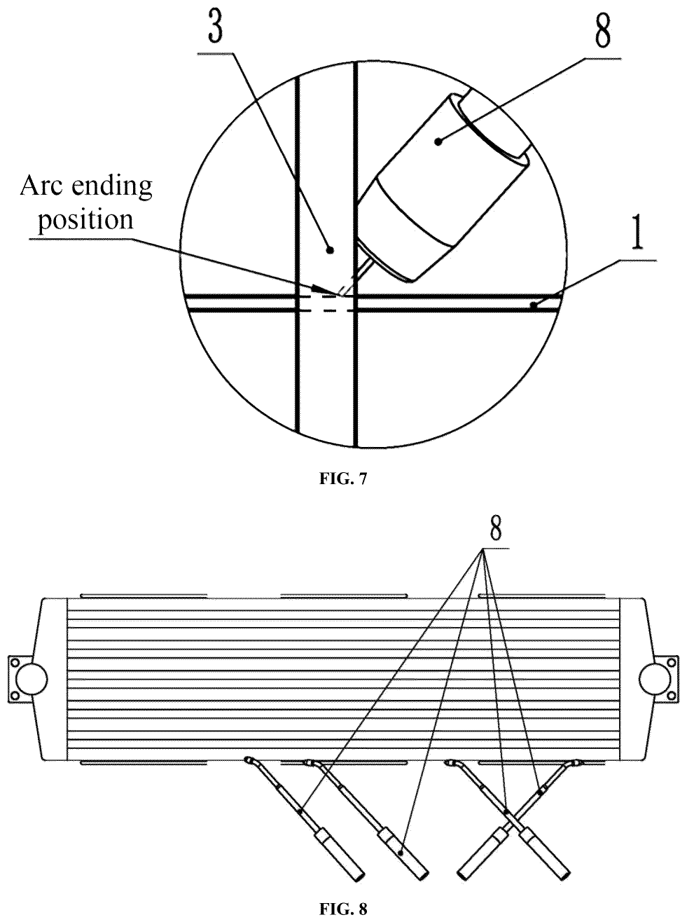

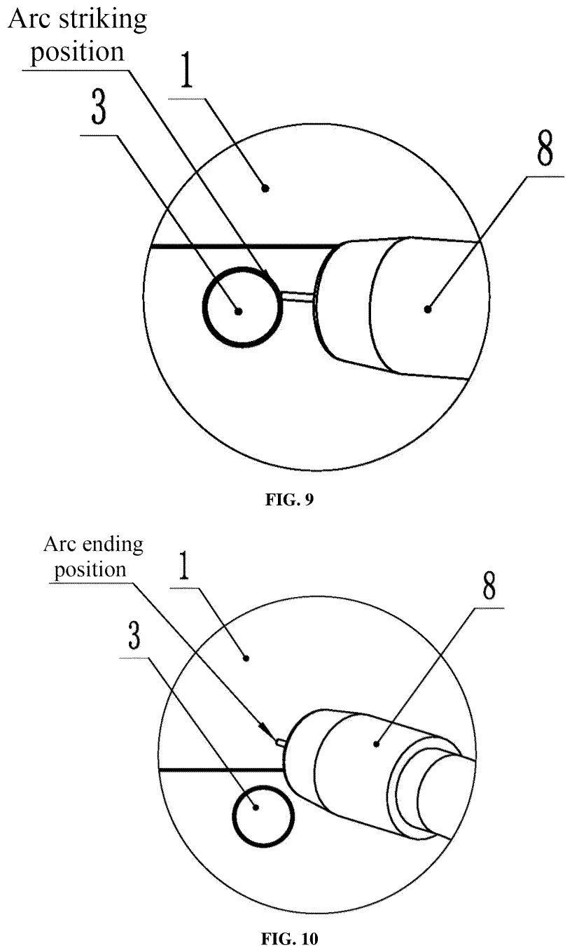

Referring to FIG. 1, FIG. 2 and FIG. 5-FIG. 10, a welding method for the panel type radiator with reinforcing ribs and cooling fins in lintel welding is as follows. First, the outer surface of the reinforcing rib 3 is arranged at an edge of a long side of the cooling fin of the radiator, and there is a gap of 3 mm between the reinforcing rib 3 and the cooling fin. Second, welding is conducted by a welding gun 8 from an arc striking position of the fusion welding region formed by the welding material and the reinforcing ribs, and then transited to a welding material fusion welding connecting lintel region to form a welding material fusion welding lintel. Afterwards, welding is conducted to an arc ending position of the fusion welding region formed by the welding material and the cooling fin to complete the lintel welding of the cooling fin 1 and the reinforcing rib 3.

The welding method for the panel type radiator with reinforcing ribs and cooling fins in lintel welding above-mentioned includes the following steps.

In step one, parameters of the lintel welding are set, a welding voltage is set to a 19 V direct current, an arc striking current is set to 120 A, an arc striking time is set to 0.5 s, a welding current is set to 100 A, a welding speed is set to 3 mm/s, an arc ending current is set to 90 A, and arc ending time is set to 0.5 s.

In step two, the radiator is placed at an attitude that the axis of the oil collecting tube 2 is perpendicular to a horizontal plane.

In step three, the outer surface of the reinforcing rib 3 is arranged on the edge 4 of the long side of the cooling fin 1 of the radiator, and there is a gap of 3 mm between the outer surface of the reinforcing rib 3 and the long-side edge of the cooling fin 1. The gap is a gap suitable for the lintel-shaped welding seam 7 arranged at the intersection of the edge 4 of the long side of the cooling fin 1 and the outer surface of the reinforcing rib 3.

In step four, the welding gun 8 is arranged at the arc striking position at a side of the reinforcing rib 3, and the arc striking position is 3 mm higher than an upper edge of the outer edge 5 of an attached position of the long side of the welded cooling fin 1.

In step 5, welding is conducted by the welding gun 8 from the arc striking position of the fusion welding region formed by the welding material and the reinforcing rib, and then transited to the welding material fusion welding connecting lintel region to form the welding material fusion welding lintel. Afterwards, welding is conducted to the arc ending position of the fusion welding region formed by the welding material and the cooling fin to complete the lintel welding of the cooling fin 1 and the reinforcing rib 3.

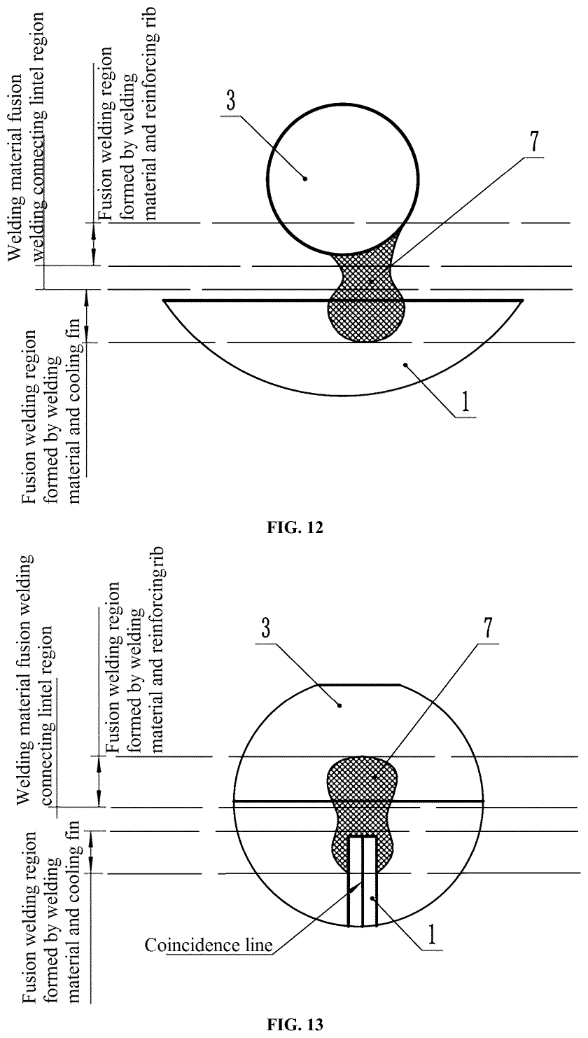

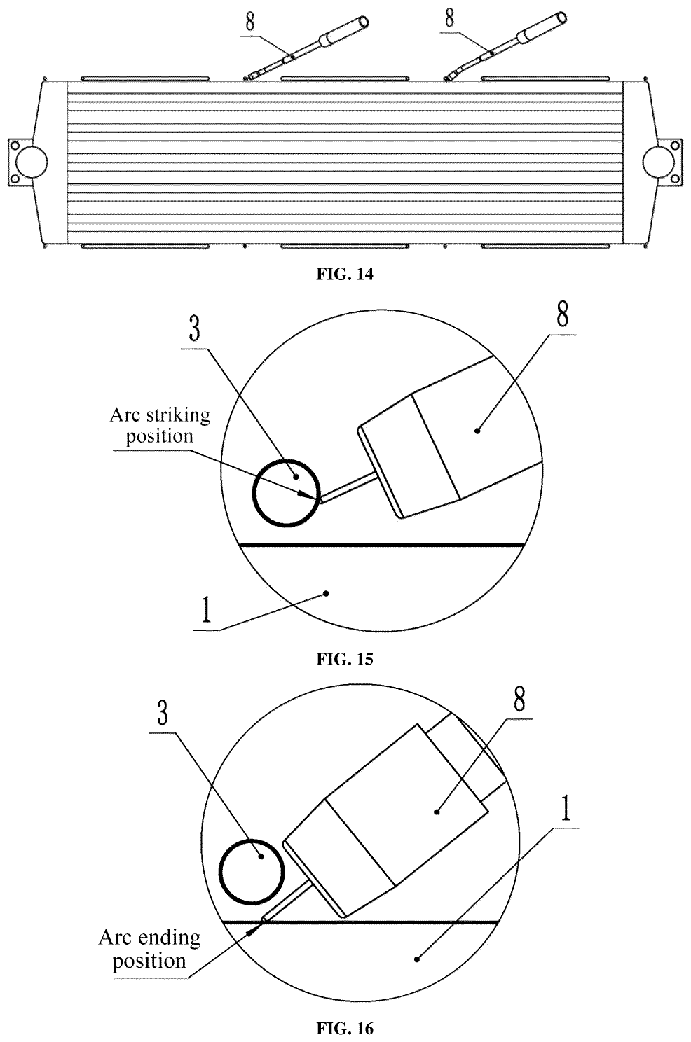

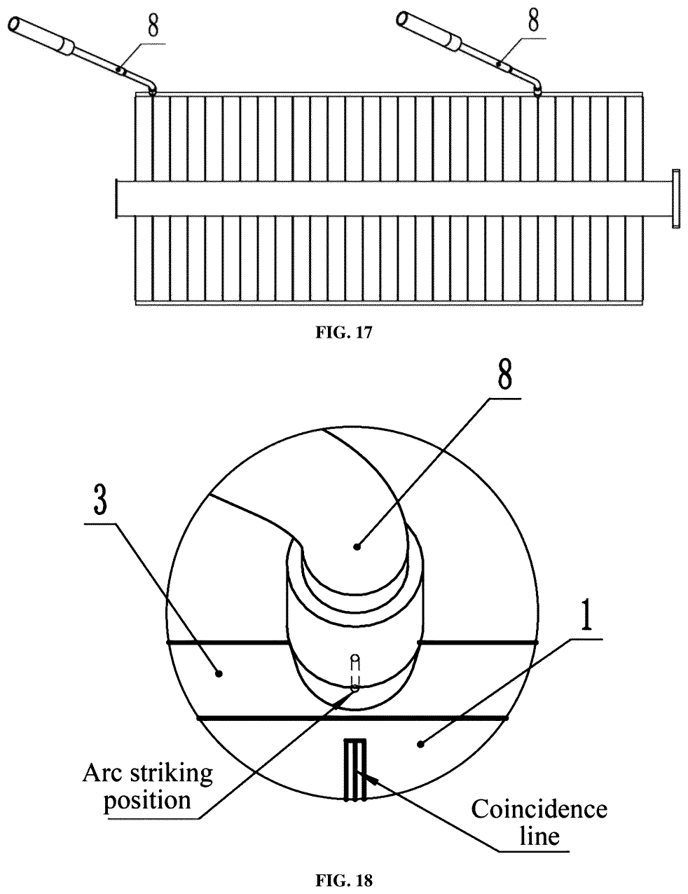

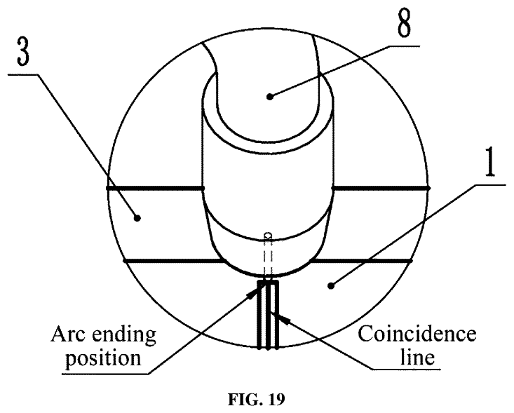

Embodiment 2: referring to FIG. 12 to FIG. 19, a welding method for the panel type radiator with reinforcing ribs and cooling fins in lintel welding includes the following steps.

In step one, parameters of the lintel welding are set, a welding voltage is set to a 19 V direct current, an arc striking current is set to 120 A, an arc striking time is set to 0.5 s, a welding current is set to 100 A, a welding speed is set to 3 mm/s, an arc ending current is set to 90 A, and an arc ending time is set to 0.5 s.

In step two, the radiator is placed at an attitude that the axis of the oil collecting tube 2 is horizontal (parallel) to the horizontal plane.

In step three, the outer surface of the reinforcing rib 3 is arranged on the edge 4 of the long side of the cooling fin 1 of the radiator, and there is a gap of 3 mm between the outer surface of the reinforcing rib 3 and the edge of the long side of the cooling fin 1.

In step four, the welding gun 8 is arranged at then arc striking position at a side of the reinforcing rib 3, and the arc striking position is vertical to a coincidence line at the attached position of the edges of the long sides of the two cooling sub-fins of the welded cooling 1.

In step 5, welding is conducted by the welding gun 8 from the arc striking position of the fusion welding region of the welding material and the reinforcing rib, and then transited to the welding material fusion welding connecting lintel region to form the welding material fusion welding lintel. Afterwards, welding is conducted to the arc ending position of the fusion welding region of the welding material and the cooling fin to complete the lintel welding of the cooling fin 1 and the reinforcing rib 3.

According to this scheme, the gap between the cooling fin of the panel type radiator for the transformer and the welded reinforcing rib is 3 mm. The welding seam is lintel-shaped, there is no welding blind zone, and thus the difficulty of visual inspection is reduced. The lintel-shaped welding seam is one point, which can achieve the reinforcement connection between the cooling fin and reduce the consumption of consumables. The gap between the cooling fin and the welded reinforcing rib is 3 mm, such that the welding defect rate is reduced, the anti-corrosion quality at the welded welding seam is improved, and the late repair rate is reduced. On the premise that the welding efficiency is improved, the anti-corrosion quality of the product is ensured, and the manufacturing cost of the product is reduced, the service life of the panel type radiator for the transformer is improved.

The above embodiments are merely used for illustrating the technical thoughts and characteristics of the present disclosure, for enabling those skilled in the art to understand the contents of the present disclosure and implement the contents accordingly, and the scope of protection of the present disclosure cannot be limited hereto. Any equivalent changes or modifications made according to the technical solutions of the present disclosure shall fall within the scope of claims of the present disclosure.

1. A panel type radiator with reinforcing ribs and cooling fins in lintel welding, comprising a plurality of cooling fins (1), two oil collecting tubes (2), a plurality of reinforcing ribs (3) and a plurality of welding seams, wherein each of the plurality of cooling fins (1) is formed by welding two cooling sub-fins oppositely arranged with a sheet thickness of 1.0-1.2 mm at attached positions of peripheral sides and attached positions of middle portions of the two cooling sub-fins;
each of the plurality of cooling fins (1) comprises: two confluence ports, one of the two confluence ports is configured for cooling fin oil (1) to divert into oil channels after entering, and another of the two confluence ports is configured for the cooling fin oil in the oil channels to flow out after confluence; and the oil channels correspondingly opposed to form an oil chamber and communicating with the two confluence ports;
the attached positions of the peripheral sides comprise two attached positions of long sides and four attached positions of short sides separated by the two confluence ports;
edges (4) of long sides of the plurality of cooling fins (1) intersect with outer surfaces of the plurality of reinforcing ribs (3), and the two attached positions of the long sides of each of the plurality of cooling fins (1) are symmetrically arranged along an axis of each of the two oil collecting tubes (2);
the plurality of welding seams comprise continuous welding seams between the two confluence ports of the plurality of cooling fins (1) and outer surfaces of the two oil collecting tubes (2), and tack welding seams (6) between outer edges (5) of the attached positions of the long sides of the plurality of cooling fins (1) and the plurality of reinforcing ribs (3), thus making lengths of diagonal lines of the panel type radiator equal and the axis of each of the two oil collecting tubes (2) perpendicular to side lines of the long sides of the plurality of cooling fins (1), and satisfying a firm connection between the plurality of cooling fins (1);
wherein:
the edges (4) of the long sides of the plurality of cooling fins (1) intersect with the outer surfaces of the plurality of reinforcing ribs (3), and gaps suitable for lintel-shaped welding seams (7) are provided at intersections;
welding material droplet welding seams are formed between the outer edges (5) of the attached positions of the long sides of the plurality of cooling fins (1) and the outer surfaces of the plurality of reinforcing ribs (3), and a shape of each of the welding material droplet welding seams is lintel-shaped; and
each of the lintel-shaped welding seams (7) is divided into three regions comprising a first fusion welding region formed by a welding material and the plurality of reinforcing ribs (3), a second fusion welding region formed by the welding material and the plurality of cooling fins (1), and a welding material fusion welding connecting lintel region between the first fusion welding region and the second fusion welding region; and the welding material fusion welding connecting lintel region is self-fusion welding metal of the welding material.

2. The panel type radiator with reinforcing ribs and cooling fins in lintel welding according to claim 1, wherein the edges (4) of the long sides of the plurality of cooling fins (1) intersect with the outer surfaces of the plurality of reinforcing ribs (3), and a gap of 1-4 mm suitable for each of the lintel-shaped welding seams (7) is arranged at a corresponding one of the intersections.

3. The panel type radiator with reinforcing ribs and cooling fins in lintel welding according to claim 2, wherein the gap is 3 mm.
